(19) United States
(12) Patent Application Publication
(10) Pub. No.: US 2026/0184905 A1
(43) Pub. Date: Jul. 2, 2026

(54) Process for Producing a Homogenous Polypropylene Composition

(71) Applicant: Borealis AG, Vienna (AT)

(72) Inventors: Lukas Sobczak, Linz (AT); Michael Hettrich-Keller, Linz (AT); Henry Sleijster, Sittard-Geleen (NL); Nikolaev Hristov Velichko, Linz (AT); Ernst Zopf, Linz (AT)

(21) Appl. No.: 19/131,330

(22) PCT Filed: Nov. 20, 2023
(86) PCT No.: PCT/EP2023/082388

§ 371 Date: May 20, 2025

(30) Foreign Application Priority Data
Nov. 21, 2022 (EP) 22208549.0

(51) Int. Cl. C08L 23/12; C08J 3/00

(52) U.S. Cl. CPC C08L 23/12; C08J 3/005; C08J 2323/12; C08J 2423/12; C08L 2205/025; C08L 2207/20

(57) ABSTRACT

A process for producing a homogenous polypropylene composition including a) Feeding and at least partially melting at least one first polypropylene (PP-A) having a first melt flow rate MFR₂ (PP-A) in an extruder, for example a twin screw extruder; b) Feeding at least one second polypropylene (PP-B) having a second melt flow rate MFR₂ (PP-B) downstream of feeding the first polypropylene (A) into said extruder, wherein the first melt flow rate MFR₂ (PP-A) is lower than the second melt flow rate MFR₂ (PP-B) and wherein the ratio of MFR₂ (PP-B)/MFR₂ (A) MFR₂ (PP-A) is ≥30; c) Compounding the at least one first polypropylene (PP-A) and the at least one second polypropylene (PP-B) in said extruder to form a homogenous polyolefin composition.

### CROSS-REFERENCE TO RELATED APPLICATIONS

This application is the United States national phase of International Patent Application No. PCT/EP2023/082388 filed Nov. 20, 2023, and claims priority to European Patent Application No. 22 208 549.0, filed Nov. 21, 2022, the disclosures of which are hereby incorporated by reference in their entireties.

### BACKGROUND

### Technical Field

The present disclosure relates to a process for producing a homogenous polypropylene composition and a homogenous polypropylene composition obtainable by said process.

### Technical Considerations

Polyolefin compositions, such as polyethylene compositions and polypropylene compositions, are often obtained from different polyolefin base polymers. For example, two different base polymers with different properties can be mixed to adjust the properties of the final polyolefin compositions.

A process for producing multimodal polyethylene blends with an ultra-high molecular weight component and a conventional polyethylene component by separately melting the ultra-high molecular weight component and the conventional polyethylene component and combining the melts has been described in WO 2016/102062 A1. Here, an ultra-high molecular weight polyethylene (A) is mixed with a conventional polyethylene (B), both in the molten state. Two homogenising devices, typically twin screw extruders, are used. Polyethylene (A) is molten in the first homogenising device, and polyethylene (B) is molten in the second one. (A) and (B) are combined and mixed in the second homogenising device. The objective is to achieve optimal homogeneity while keeping degradation from mixing energy input at a minimum.

EP 3 757 152 A1 describes adjusting the MFR of a mixed-plastic-polyethylene blend with a peroxide (POX) in an extruder.

US 2013/0046034 A1 discloses the melt flow rate control of polyolefin mixtures. A mixture of polyethylene and polypropylene is treated with a POX in a compounding step. The melt flow rate (MFR) of the product is controlled by adjusting the ratio of polyethylene to polypropylene and/or the amount of POX added.

U.S. Pat. No. 10,766,981 B2 describes bimodal polypropylene blends with a specific flexural modulus and other defined properties. Also disclosed is a so-called two-pass process to make those compositions, basically meaning that the blend is compounded two times (double compounding).

EP 1 473 137 A1 describes a cascade of two twin screw extruders for the purpose of homogenizing bimodal polyolefins. The publication specifies the screw diameter ratios, screw speeds, and other process conditions and equipment details. The starting material used in this case is based on one polyolefin, already containing low and high MW components; i.e., only one polyolefin is homogenized.

US 2005/0228141 A1 discloses a process for producing polypropylene resin composites including two or three types of propylene based polymeric materials. The process includes a first step of melt kneading a first copolymer I and a second step of melt-kneading the product of the first step with a second copolymer II. It is also described to add a third homopolymer III. The process is carried out in a twin extruder (TEM-50A) at a screw speed of 200 rpm and a discharge rate of 30 kg/hr.

EP 1 086 986 A1 refers to a propylene resin composition (A) comprising a PP homopolymer and/or PP-PE copolymer (A-1) and a PP-PE copolymer (A-2), wherein (A-1) has a lower viscosity than (A-2). The polymers (A-1) and (A-2) can be mixed using different kneading methods. The component (A-1) may have melt flow rate (g/10 min) between 110 and 600, and the component (A-2) may have melt flow rate (g/10 min) between 2.2 and 14.8.

However, it remains a challenge to obtain homogenous polypropylene compositions from different polypropylene base polymers with a comparatively large viscosity ratio in a process with good productivity. Such polypropylene compositions are inherently difficult to homogenize due to their large difference in viscosities. This is difficult, when one of the polypropylene polymers as part of the polypropylene composition has a very low melt flow rate such as below 2 g/10 min for example a melt flow rate of about 0.2-0.3 g/10 min.

Furthermore, when polypropylenes in powder form are used, the large difference in particle size of the various reactor powder particles makes homogenizing even more challenging. Typically, the polypropylene with the lower molecular weight melts first, creating a low viscous melt. In that melt, it is difficult to transfer enough energy for complete melting to the pellets or powder particles of the second polypropylene with a higher molecular weight. For such formulations, a procedure that would provide improved homogeneity of the polypropylene blend might allow a significant improvement in blend properties.

This problem of mixing polymers with large viscosity gap also occurs when using post-consumer recyclates. Typical polypropylene post-consumer recyclates have a melt flow rate MFR₂ of above 10 g/10 min. This flowability range is suitable for many injection molding applications. However, typical packaging processes like cast film extrusion and thermoforming require lower MFRs. By mixing polypropylene recyclates with high molecular weight, highly viscous polypropylene, the melt flow rates could be steered into the required direction. However this would lead to the mentioned viscosity ratio challenge.

### SUMMARY

Thus, it is an objective of the present disclosure to provide a compounding process for homogenous polypropylene blends obtained from a polypropylene with a low molecular weight and a polypropylene with a high molecular weight causing a large viscosity gap. It was furthermore an object of the disclosure to provide such a process with a good productivity. This object has been solved by providing a process for producing a homogenous polypropylene composition comprising the following steps:
a) Feeding and at least partially melting at least one first polypropylene (PP-A) having a first melt flow rate MFR₂ (PP-A) in an extruder, for example a twin screw extruder; wherein the at least one first polypropylene (PP-A) has a melt flow rate MFR₂ (230° C., 2.16 kg, measured according to ISO 1133) of ≤2.0 g/10 min;
b) Feeding at least one second polypropylene (PP-B) having a second melt flow rate MFR₂ (PP-B) downstream of feeding the first polypropylene (PP-A) into said extruder;
wherein the first melt flow rate MFR₂ (PP-A) is lower than the second melt flow rate MFR₂ (PP-B) and wherein the ratio of MFR₂ (PP-B)/MFR₂ (PP-A) is ≥30;
c) Compounding the at least one first polypropylene (PP-A) and the at least one second polypropylene (PP-B) in said extruder to form a homogenous polyolefin composition, wherein the process is carried out in an extruder with a dimensionless throughput Q of >0.035.

Thus, a process is provided wherein a high molecular weight, highly viscous first polypropylene is fed into an extruder, where it is at least partially melted. The low molecular weight, less viscous second polypropylene is subsequently fed to the melt of the first polypropylene into the extruder downstream of the feeding point of the first polypropylene: i.e., a low viscous polypropylene is added to a high viscous polypropylene in an extruder. This feeding order provides surprisingly an improved homogeneity compared to conventional extruding processes, wherein both polypropylenes are fed together into the main hopper of the extruder.

Within the context of the present process the term “Downstream” is related to the direction of polymer flow. In an extruder, polymer flows from the inlet end towards the outlet end. In that sense, location B (feeding second polypropylene PP-B) is downstream of location A (feeding first polypropylene PP-A); i.e., location B is closer to the outlet end of the extruder, while location A is closer to the inlet end (or at the inlet end) of the extruder.

When compounding polypropylene base polymers with a large viscosity ratio the present process allows for improved homogenisation and thus better final compound properties of the compound product. In recycling, the present process permits to reach an MFR range lower than what is accessible from typical (post-consumer) feedstocks, allowing polypropylene recyclates (rPP) to enter new applications. The melt-mixing setup of the present process allows for excellent homogenisation of the high molecular weight polypropylene with the lower melt flow rate and the low molecular weight polypropylene with the higher melt flow rate, which is not possible when just feeding both polypropylenes to the same feed port of the extruder or feeding the former to the extruder downstream of the latter. For adjustment of the melt flow rate, the present process allows to use a polypropylene with a very low melt flow rate (as first polypropylene PP-A), therefore only relatively low amounts of the latter are required to reach the product target melt flow rate. In recycling, the right melt-mixing setup allows to compensate variations in the rPP melt MFR.

A polypropylene composition according to the present disclosure denotes a polymer derived from at least 50 mol-% propylene monomer units and additional comonomer units.

The term ‘homopolymer’ thereby denotes a polymer consisting essentially of propylene monomer units. Due to the requirements of large-scale polymerization it may be possible that the propylene homopolymer comprises minor amounts of additional comonomer units, which usually are below 0.05 mol %, preferably below 0.01 mol % of the propylene homopolymer. Accordingly, the term ‘copolymer’ denotes a polymer derived from propylene monomer units and additional comonomer units in an amount of more than 0.05 mol %.

The term “virgin” (as used further below) denotes the newly produced materials and/or objects prior to first use and not being recycled. In case that the origin of the polymer is not explicitly mentioned the polymer is a “virgin” polymer.

For the purposes of the present description and of the subsequent claims, the term “recycled” is used to indicate that the material is recovered from post-consumer waste and/or industrial waste. Namely, post-consumer waste refers to objects having completed at least a first use cycle (or life cycle), i.e., having already served their first purpose and been through the hands of a consumer; while industrial waste refers to the manufacturing scrap which does normally not reach a consumer. “Recycled polymers” may also comprise up to 17 wt %, preferably up to 3 wt %, more preferably up to 1 wt % and even more preferably up to 0.1 wt % based on the overall weight of the recycled polymer of other components originating from the first use. Type and amount of these components influence the physical properties of the recycled polymer. The physical properties given below refer to the main component of the recycled polymer.

Usually, a polypropylene composition comprising at least two polypropylene fractions, which have been produced under different polymerization conditions resulting in different (weight average) molecular weights for the fractions, is referred to as “multimodal”. The prefix “multi” relates to the number of different polymer fractions the composition consists of. Thus, for example, a composition consisting of two fractions only is called “bimodal”, whereas a composition consisting of three fractions is called “trimodal”.

For describing the molecular weight of a polyolefin resin or component several statistical methods are known in the art. In practice three averages are used, representing the weighted mean taken with the mole fraction, the weight fraction, and the weight fraction to the power of two:

$$Number average molar mass or Mn ( also referred to as Number Average Molecular Weight ) with Mn = \sum MiNi / \sum Ni$$

$$Mass average molar mass or Mw ( w is for weight ; also referred to as weight average ) with Mw = \sum {Mi}^{2} Ni / \sum MiNi$$

$$Z average molar mass or Mz with Mz = \sum {Mi}^{3} Ni / \sum {Mi}^{2} Ni$$

The term ‘base resin’ denotes the polymeric part of the composition without fillers such as, for example, carbon black and/or talc. A person skilled in the art will understand that the measurements as to the base resin require the presence of stabilizers.

In some non-limiting embodiments of the present process, the ratio of MFR₂ (B)/MFR₂ (A) is ≥50, preferably ≥60, more preferably ≥70, even more preferably ≥100, such as ≥200, preferably ≥300, more preferably ≥350.

As will be described in detail further below, it is possible to use virgin polypropylene and/or recycled polypropylene both as polypropylene (PP-A) and polypropylene (PP-B). If recycled polypropylene is used, for example as polypropylene (PP-B), the MFR₂ (PP-B)/MFR₂ (PP-A) may be 30 to 200. If virgin polypropylenes are used, for example for obtaining a bimodal composition, the MFR₂ (PP-B)/MFR₂ (PP-A) may be 30 to 200 or higher than 200.

In some non-limiting embodiments, the at least one first polypropylene (PP-A) is provided in an amount of 2 to 45 wt %, preferably 3 to 40 wt %, more preferably 4 to 35 wt %, even more preferably 5 to 30 wt %, such as 5-15 wt %, 20-25 wt % or 24 to 36 wt % (based on the overall weight of the polyolefin composition).

The at least one second polypropylene (PP-B) is provided in an amount of 55 to 98 wt %, preferably 60 to 97 wt %, more preferably 65 to 96 wt %, even more preferably 70 to 95 wt %, such as 85-95 wt %, 75-80 wt % or 64 to 76 wt % (based on the overall weight of the polyolefin composition).

### First Polypropylene Polymer (PP-A)

The first polypropylene (PP-A) may be a virgin polypropylene homopolymer or a virgin polypropylene copolymer.

According to the present disclosure, the at least one first polypropylene (PP-A) has a melt flow rate MFR₂ (230° C., 2.16 kg, measured according to ISO 1133) of ≤2.0 g/10 min, preferably in the range of 0.10 to 1.0 g/10 min, more preferably of 0.15 to 0.50 g/10 min, even more preferably of 0.2 to 0.30 g/10 min.

The first polypropylene (PP-A) may be also a polypropylene of recycled material, for example obtained in a chemical recycling or so called feedstock recycling process, comprising solvolysis and thermochemical processing. Chemical recycling technologies can break down plastics into its building blocks and transform them into valuable secondary raw materials. This provides a promising opportunity to recover pre-sorted and pre-treated solid plastic waste to obtain feedstocks for the petrochemical industry, which may be processed to plastics again, as well as to chemical commodities and fuels.

The properties of different virgin propylene polymers usable as first polypropylene (PP-A) are described in more detail in the following.

### Polyproylene Polymer (PP-A1)

In a non-limiting embodiment, the polypropylene polymer (PP-A1) may be a propylene homopolymer having a melt flow rate MFR₂ (230° C., 2.16 kg, measured according to ISO 1133) in the range of ≤2.0 g/10 min, preferably ≤1.5 g/10 min, preferably in the range of 0.10 to 1.0 g/10 min, more preferably of 0.15 to 0.50 g/10 min, even more preferably of 0.2 to 0.30 g/10 min.

Generally, the polypropylene polymer (PP-A1) has an average molecular weight (M_{w}) in the range of 300 to 1200 kg/mol, preferably in the range of 400 to 1000 kg/mol, more preferably in the range 500 to 800 kg/mol, like 500-755 kg/mol.

The polypropylene polymer (PP-A1) may have a number average molecular weight Mn of 50-300 kg/mol, preferably of 100-200 kg/mol, like 140-162 kg/mol.

The average molar mass Mz of the polypropylene polymer (PP-A1) may be 500-3000 kg/mol, preferably 800-2500 kg/mol, like 1060-2250 kg/mol.

The polypropylene polymer (PP-A1) consists substantially, i.e., of more than 99.7 wt.-%, still more preferably of at least 99.8 wt.-%, of propylene units, based on the weight of the propylene polymer. In some non-limiting embodiments only propylene units are detectable in the propylene polymer; i.e., the first polypropylene (PP-A) is preferably a homopolymer.

The polypropylene polymer (PP-A1) may have a Charpy Notched Impact Strength (NIS) measured according to ISO 179-1 eA at 23° C. in the range of 5-10 kJ/m², preferably of 7 kJ/m². The propylene polymer (PP-A1) may have a tensile modulus measured according to ISO 527-2 of at least 1000 MPa, preferably at least 1500 MPa, more preferably in the range of 1000 to 2000 MPa, like 1650 MPa.

The polypropylene polymer (PP-A1) is known in the art and commercially available.

### Polypropylene Polymer (PP-A2):

In some non-limiting embodiments, the polypropylene polymer (PP-A2) may be a propylene copolymer having a melt flow rate MFR₂ (230° C., 2.16 kg, measured according to ISO 1133) in the range of ≤2.0 g/10 min, preferably in the range of 0.10 to 1.0 g/10 min, more preferably of 0.15 to 0.50 g/10 min, even more preferably of 0.2 to 0.30 g/10 min.

The polypropylene polymer (PP-A2) may have a Charpy Notched Impact Strength (NIS) measured according to ISO 179-1 eA at 23° C. in the range of 50-100 kJ/m², preferably of 70 kJ/m². The propylene polymer (PP-A2) may have a flexural modulus measured according to ISO 178 of at least 1000 MPa, preferably at least 1200 MPa, more preferably in the range of 1000 to 2000 MPa, like 1400 MPa.

The polypropylene polymer (PP-A2) is known in the art and commercially available.

### Polypropylene Polymer (PP-A3):

In some non-limiting embodiments, the polypropylene polymer (PP-A3) may be a random polypropylene having a melt flow rate MFR₂ (230° C., 2.16 kg, measured according to ISO 1133) in the range of ≤2.0 g/10 min, preferably in the range of 0.10 to 1.0 g/10 min, more preferably of 0.15 to 0.50 g/10 min, even more preferably of 0.2 to 0.30 g/10 min, such as 0.17-0.29 g/10 min.

The polypropylene polymer (PP-A3) may have a Charpy Notched Impact Strength (NIS) measured according to ISO 179-1 eA at 23° C. in the range of 10-30 kJ/m², preferably of 20 kJ/m². The propylene polymer (PP-A2) may have a tensile modulus measured according to ISO 527-2 of at least 500 MPa, preferably at least 800 MPa, more preferably in the range of 500 to 1000 MPa, like 850 MPa.

The polypropylene (PP-A3) is known in the art and commercially available.

### Polypropylene Polymer (PP-A4):

In some non-limiting embodiments, the polypropylene polymer (PP-A4) may be a random heterophasic polypropylene copolymer having a C2 content of 10 to 18 wt %, preferably 11-15 wt %, and an OCS gel index of ≤18.

The polypropylene (PP-A4) is known in the art and commercially available.

Second Polypropylene Polymer (PP-B)

The second polypropylene (PP-B) may be a polypropylene homopolymer, a polypropylene copolymer or a polypropylene blend of recycled material.

In some non-limiting embodiments, the at least one second polypropylene (PP-B) has a melt flow rate MFR₂ (230° C., 2.16 kg, measured according to ISO 1133) in the range of 9 to 1000 g/10 min, preferably of 10 to 500 g/10 min, more preferably 12 to 100 g/10 min, even more preferably of 15 to 90 g/min, still more preferably of 10 to 85 g/10 min.

The at least one second polypropylene (PP-B) may have an average molecular weight in the range of 25 to 400 kg/mol, preferably 100 to 350 kg/mol, more preferably of 130 to 280 kg/mol.

The at least one second polypropylene (PP-B) may have a number average molecular weight Mn of 10-45 kg/mol, preferably of 15-35 kg/mol, like 20-34 kg/mol.

The average molar mass Mz of the at least one second polypropylene may be 80-1500 kg/mol, preferably 400-1000 kg/mol, like 400-830 kg/mol.

The properties of different propylene polymers usable as polypropylene polymer (PP-B) are described in more detail in the following.

### Polypropylene Polymer (PP-B1):

In some non-limiting embodiments, the polypropylene polymer (PP-B1) has a melt flow rate MFR₂ (230° C., 2.16 kg, measured according to ISO 1133) in the range of 60 to 100 g/10 min, preferably of 70 to 90 g/10 min, more preferably of 80 to 85 g/10 min.

The polypropylene polymer (PP-B1) may have an average molecular weight in the range of 50 to 300 kg/mol, preferably 100 to 200 kg/mol, more preferably of 135 to 150 kg/mol.

The polypropylene polymer (PP-B1) may have a number average molecular weight Mn of 10-30 kg/mol, preferably of 15-25 kg/mol, like 20-24 kg/mol.

The average molar mass Mz of the polypropylene (PP-B1) may be 300-1000 kg/mol, preferably 400-500 kg/mol, like 400-480 kg/mol.

The polypropylene polymer (PP-B1) consists substantially, i.e., of more than 99.7 wt.-%, still more preferably of at least 99.8 wt.-%, of propylene units, based on the weight of the propylene polymer. In some non-limiting embodiments only propylene units are detectable in the propylene polymer; i.e., the second polypropylene is preferably a homopolymer.

It is appreciated that the polypropylene polymer (PP-B1) features a low amount of xylene cold soluble (XCS) fraction. The polypropylene polymer (PP-B1) may have an amount of xylene cold soluble (XCS) fraction of not more than 4.0 wt.-%, preferably not more than 3.5 wt.-%, like in the range of 0.1 to 4.0 wt.-%, preferably in the range of 0.1 to 3.5 wt.-%, based on the weight of the polypropylene polymer (PP-B1).

The polypropylene polymer (PP-B1) may have a heat deformation temperature (HDT) measured according to ISO 75-2 of at least 50° C., preferably at least 60° C., more preferably at least 75° C., like in the range of 50 to 120° C., preferably in the range of 60 to 100° C., more preferably 75 to 90° C.

The polypropylene polymer (PP-B1) may have a Charpy Notched Impact Strength (NIS) measured according to ISO 179-1 eA at 23° C. of at least 0.5 kJ/m², preferably, at least 0.7 kJ/m², like in the range of 0.5 to 1.5 kJ/m², preferably in the range of 0.7 to 1.3 kJ/m², like 1.0 kJ/m². The polypropylene polymer (PP-B1) may have a flexural modulus measured according to ISO 178 of at least 500 MPa, preferably at least 1000 MPa, like in the range of 500 to 2500 MPa, preferably in the range of 1000 to 2000 MPa, like 1500 MPa.

The polypropylene polymer (PP-B1) is known in the art and commercially available.

### Polypropylene Polymer (PP-B2):

In some non-limiting embodiments, the polypropylene polymer (PP-B2) has a melt flow rate MFR₂ (230° C., 2.16 kg, measured according to ISO 1133) in the range of 5 to 30 g/10 min, preferably of 8 to 25 g/10 min, more preferably of 10 to 20 g/10 min, like 10 to 15 g/10 min.

The polypropylene polymer (PP-B2) may have a heat deformation temperature (HDT) measured according to ISO 75-2 of at least 50° C., preferably at least 60° C., more preferably at least 75° C., like in the range of 50 to 120° C., preferably in the range of 60 to 100° C., more preferably 75 to 90° C.

The polypropylene polymer (PP-B2) may have a Charpy Notched Impact Strength (NIS) measured according to ISO 179-1 eA at 23° C. of at least 2.5 kJ/m², preferably at least 3.0 kJ/m², like in the range of 2.5 to 4.0 kJ/m², preferably in the range of 3.3 to 3.7 kJ/m², like 3.5 kJ/m². The polypropylene polymer (PP-B2) may have a tensile modulus measured according to ISO 178 of at least 500 MPa, preferably at least 1000 MPa, like in the range of 500 to 2500 MPa, preferably in the range of 1000 to 2000 MPa, like 1500 MPa.

The polypropylene polymer (PP-B2) is known in the art and commercially available.

As mentioned, the second polypropylene (PP-B) may be also a mixed-plastics polypropylene blend of recycled material, for example a recyclate blend obtained in a mechanical recycling process as described in the following in more detail.

Propylene Blend of Recycled Material from a Mechanical Recycling Process as Second Polypropylene (PP-B)

Such a blend is obtained from a recycled waste stream. The blend can be either recycled post-consumer waste or post-industrial waste, such as for example from the automobile industry, or alternatively, a combination of both. It is preferred that the blend consists of recycled post-consumer waste and/or post-industrial waste.

In some non-limiting aspects, the blend may be a polypropylene (PP) rich material of recycled plastic material that comprises significantly more polypropylene than polyethylene. Recycled waste streams, which are high in polypropylene can be obtained for example from the automobile industry, for example as some automobile parts such as bumpers are sources of fairly pure polypropylene material in a recycling stream or by enhanced sorting. PP rich recyclates may also be obtained from yellow bag feedstock when sorted accordingly. The PP rich material may be obtainable by selective processing, degassing and filtration and/or by separation according to type and colors such as NIR or Raman sorting and VIS sorting. It may be obtained from domestic waste streams (i.e., it is a product of domestic recycling) for example the “yellow bag” recycling system organized under the “Green dot” organization, which operates in some parts of Germany.

Mechanical recycling processes typically include separation steps such as shredding, vibrating/rotary sieving, advanced sorting methods supported by spectrometric-methods [e.g., NIR/VIS] and/or wash operations to reduce organic, biologic and/or partly odor contaminants primary from the surface of the recyclable plastic material, as well as achieving a polymer type enriched and more homogenous polymer recyclate fraction (e.g., of 85 to 95 wt % of a respective polymer type).

Preferably, the polypropylene rich recycled material is obtained from recycled waste by means of plastic recycling processes known in the art. Such PP rich recyclates are commercially available, e.g., from Corepla (Italian Consortium for the collection, recovery, recycling of, packaging plastic wastes), Resource Plastics Corp. (Brampton, ON), Kruschitz GmbH, Plastics and Recycling (AT), Vogt Plastik GmbH (DE), mtm Plastics GmbH (DE), etc. Non-exhaustive examples of polypropylene rich recycled materials comprise: Dipolen®PP, Purpolen®PP (Mtm Plastics GmbH), MOPRYLENE PC B-420 White, MOPRYLENE PC B 440 Light Jazz (Morssinkhof Plastics, NL), SYSTALEN PP-C24000; Systalen PP-C44000; Systalen PP-C14901, Systalen PP-C17900, Systalen PP-C2400, Systalen 13704 GR 015, Systalen 13404 GR 014, Systalen PP-C14900 GR000 (Der Grüne Punkt, DE), Vision (Veolia) PPC BC 2006 HS and/or PP MONO.

The mixed-plastics polypropylene blend of recycled material typically has a melt flow rate (ISO1133, 2.16 kg; 230° C.) of 2.0 to 50 g/10 min. The melt flow rate can be influenced by splitting post-consumer plastic waste streams, for example, but not limited to: originating from extended producer's responsibility schemes, like from the German DSD, or sorted out of municipal solid waste into a high number of pre-sorted fractions and recombine them in an adequate way. As a further way of modifying melt flow rate of the final mixed-plastics polypropylene blend peroxides can be introduced in the final pelletization step. Usually MFR ranges from 2.0 to 50 g/10 min, preferably from 5.0 to 40 g/10 min, more preferably from 10 to 30 g/10 min, and most preferably from 15 to 25 g/10 min. This MFR range may be suitable for the non-visbroken mixed-plastics polypropylene blend. Visbreaking allows increase of MFR to 30 g/10 min or 40 g/10 min or even up to 100 g/10 min.

The propylene blend of recycled material may be obtained in a mechanical recycling process comprising sieving a mixed plastic recycling stream, sorting the sieved mixed plastic recycling stream at least by colour and optionally by polyolefin type and/or article form thereby generating one or more single-colour sorted polyolefin recycling stream(s) and a mixed-colour sorted polyolefin recycling stream, wherein each of the single-colour sorted polyolefin recycling stream(s) and the mixed-colour sorted polyolefin recycling stream are then subjected separately to a size reduction step in order to receive a flaked polyolefin recycling stream, a cold washing step, a washing step at a temperature from 65 to 95° C., a drying step, a further sorting step, and optionally a melt extruding step to receive an extruded, preferably pelletized, recycled polyolefin product, which process additionally can comprise an aeration step prior or after the extrusion step to remove volatile organic compounds finally obtaining an extruded, preferably pelletized, aerated recycled polyolefin product.

According to some non-limiting embodiments, the mixed plastics polypropylene blend has
(i) a crystalline fraction (CF) content determined according to CRYSTEX QC analysis in the range from 86.0 to 94.0 wt.-%, and
(ii) a soluble fraction (SF) content determined according to CRYSTEX QC analysis in the range from 6.0 to 14.0 wt.-%, whereby
(iii) said crystalline fraction (CF) has a propylene content (C3(CF)) as determined by FT-IR spectroscopy calibrated by quantitative ¹³C-NMR spectroscopy, in the range from 95.0 to 99.0 wt.-%; preferably 96.0 to 98.0 wt.-% and whereby
(iv) said crystalline fraction (CF) has an ethylene content (C2(CF)), as determined by FT-IR spectroscopy calibrated by quantitative ¹³C-NMR spectroscopy, in the range from 1.0 to 5.0 wt.-% preferably 2.0 to 4.0 wt.-%, more preferably 2.5 to 3.5 wt.-%; and
(v) said soluble fraction (SF) has an intrinsic viscosity (iV(SF)) in the range from 1.10 to below 1.50 dl/g, preferably 1.25 to 1.45 dl/g; and whereby
(vi) the mixed-plastics polypropylene blend has inorganic residues as measured by calcination analysis (TGA) according to DIN ISO 1172:1996 of 0.05 to 3.0 wt.-%, preferably 0.05 to 2.5 wt.-%, optionally 1.0 to 2.5 wt.-% with respect to the mixed-plastics polypropylene blend; and whereby
(vii) the mixed-plastics polypropylene blend has a CIELAB color space (L*a*b*) of
   L* from 72.0 to 97.0 preferably from 80.0 to 97.0;
   a* from −5.0 to 0.0;
   b* from 0.0 to below 22.0.

Alternatively, the mixed-plastics polypropylene blend has
(i) a crystalline fraction (CF) content determined according to CRYSTEX QC analysis, as determined herein, in the range from 85.0 to 95.0 wt.-%,
(ii) a soluble fraction (SF) content determined according to CRYSTEX QC analysis, as determined herein, in the range from 5.0 to 15.0 wt.-%,
(iii) a total ethylene content (C2), determined according to CRYSTEX QC analysis, as determined herein, in the range from 2.0 to 10.0 wt.-%,
(iv) said crystalline fraction (CF) has a propylene content (C3(CF)) as determined by FT-IR spectroscopy calibrated by quantitative ¹³C-NMR spectroscopy, as determined herein, in the range from 93.0 to 99.0 wt.-%;
(v) said crystalline fraction (CF) has an ethylene content (C2(CF)), as determined by FT-IR spectroscopy calibrated by quantitative ¹³C-NMR spectroscopy, as determined herein, in the range from [C2]-3.4 wt.-% to [C2]-0.2 wt.-%, wherein [C2] is the total ethylene content (C2) defined in (iii),
(vi) a CIELAB color space (L*a*b*) measured according to DIN EN ISO 11664-4, as described herein, of
   L* from 30.0 to 73.0;
   a* from −10 to 25;
   b* from −5 to 20.

Alternatively, the second polypropylene (PP-B) may be a mixed-plastics polypropylene blend of recycled material obtained in a solvent based Recycling process (SbR). In SbR-processing the polymer is initially dissolved in an appropriate solvent and next either the solubility of the dissolved polymer is decreased by the addition of a non-solvent (dissolution/precipitation) and/or solidification of the polymer is caused by the preferably complete separation of the solvent from the solidified polymer by thermal unit operations (evaporation, drying etc.). The main advantages of SbR-processing can be found in the preservation of the original molecular structure and the mostly relevant properties, density and MFR, for re-processing (compounding, conversion), and in the possibility to separate polymer additives, e.g., fillers, stabilizers, anti-oxidants and/or pigments, to gain a virgin-like high-quality polyolefin, which can be finally adjusted to the desired polyolefin grade by compounding.

The framework of commonly known waste plastics material solvent based recycling processes includes the removal of impurities, dissolution, and reprecipitation/recrystallization and/or devolatilization of the polymer. Specifically, the one or more polymer is dissolved in one or more solvent, and subsequently, each polymer is selectively precipitated/crystallized. Ideally, if a solvent can dissolve either the target polymer or all the other polymers except the target polymer, it can be used for selective dissolution.

In some non-limiting embodiments, the first polypropylene (PP-A) is a polypropylene of recycled material obtained in a chemical recycling or so called feedstock recycling process, and the second polypropylene (PP-B) is a polypropylene blend of recycled material obtained in a mechanical recycling process or in a solvent based recycling process (SbR). In some non-limiting embodiments wherein the first polypropylene (PP-A) is a polypropylene obtained in a chemical recycling or so called feedstock recycling process, and the second polypropylene (PP-B) is a polypropylene obtained in a solvent based Recycling process (SbR) is preferred. Such embodiments enable a content of recycled polypropylene close to 100%, being thus very environmentally friendly options for the process according to the present disclosure.

### Process

As mentioned above, the process according to the present disclosure is carried out in an extruder with a dimensionless throughput Q of >0.035, preferably >0.055, more preferably >0.075.

The dimensionless throughput Q is defined according to following formula:

$$Q [ - ] = \frac{\dot{m}}{{ρ}_{m} * {d}^{3} * n}$$

with \dot{m} being the throughput rate on the extruder in [kg/s], ρₘ being the melt density in [kg/m³] (typically 740 kg/m³ is used for neat PP melts), d being the screw diameter of the extruder in [m], and n being the screw speed of the extruder in [rev./s].

As it is well known in the art, throughput rates across different extruder sizes can be compared by calculating the dimensionless throughput Q. It can also be used to assess the productivity of a compounding or extrusion process in general.

Obviously, the higher Q, the higher is the degree of filling of the extruder as a whole, and the productivity of the process. Also, typically, higher Q values go along with reduced specific energy input in [kWh/kg], and, in turn, reduced melt temperature. Therefore, high Q values are preferable in production processes.

In the process according to the present disclosure, the first polypropylene (PP-A) having a high molecular weight and low melt flow rate is homogenised by at least partially melting in an extruder, for example a twin screw extruder.

The first polypropylene (PP-A) can be fed to the extruder as pellets or as powder, preferably via the main hopper.

Extruders can be classified as small extruders and large extruders. An extruder is denoted as small if the temperature of the melt in the extruder effectively could be influenced by the extruder barrel temperatures by heat conduction, i.e., by external heating or cooling of the barrel.

The set point for the barrel temperature in the extruder is preferably from 170° C. to 250° C., more preferably from 180° C. to 240° C. and most preferably from 190° C. to 230° C. For small extruders and also for large extruders during the start-up the barrels are typically heated, for instance, by electric bands. However, as it is well understood by the person skilled in the art large extruders generally operate adiabatically and then the barrel temperatures are not controlled and practically linked to the temperatures generated in the melt along the length of the extruder.

The extruder comprises a melting section between the main hopper as feed port for feeding the at least one first polypropylene (PP-A) and a feed port downstream of the main hopper for feeding the at least one second polypropylene (PP-B).

The first polypropylene (PP-A) is at least partially melted in the melting section. It is preferred that at least 20 wt %, more preferably at least 50 wt %, still more preferably at least 75 wt % and most preferably at least 95 wt % of the first polypropylene (PP-A) is melted within the melting section. In some non-limiting embodiments, 100 wt % of the first polypropylene (PP-A) is melted when exiting the melting section.

It is then preferred that the distance between the first feed port (main hopper) for the first polypropylene (PP-A) and the second feed port for the second polypropylene (PP-B) and thus the length of the melting section would be such that the ratio of said distance to the screw diameter would not be less than 8.

As mentioned above, the second polypropylene (PP-B) is fed into the extruder via a feed port downstream of the main hopper, either in the form of solids, like powder or pellets, or in the form of a melt. Thus, the second polypropylene (PP-B) is combined at this point with the at least partially, preferably completely molten first polypropylene (PP-A). Downstream of said second feeding zone the combined first polypropylene (PP-A) and second polypropylene (PP-B) are blended to form a polypropylene composition.

If the second polypropylene (PP-B) is fed in solid form, the screw design of the extruder must be suitable to achieve both melting of the second polypropylene (PP-B) and homogeneous mixing of the first and the second polypropylene downstream of the second feeding zone. If the second polypropylene (PP-B) is fed in molten form, the screw design must be suitable to only mix homogeneously the first and the second polypropylene downstream of the second feeding zone.

In some non-limiting embodiments, the at least one second polypropylene (PP-B) is fed to the extruder as a melt. In this case the second polypropylene (PP-B) is homogenised by at least partially melting in a side extruder connected to the main extruder via a pipe. It is also possible that the melt of the second polypropylene (PP-B) is transferred directly from a reactor or a solvent-based or a mechanical recycling process.

In some non-limiting embodiments, the at least one second polypropylene (PP-B) is fed to the extruder as a solid, for example as a pellet or powder. In this case, the solid is fed to the extruder via a side feeder or a vertical feed hopper being connected to the feed port.

Where large extruders are used near the polymer production facilities (of polypropylene (PP-B)) it is usually more convenient to feed the second polypropylene (PP-B) as powder. On the other hand, for small extruders or where the extruder is located far away from the production facilities it may be more convenient to feed the second polypropylene (PP-B) as pellets.

The screw speed of the extruder is at least 100 rpm; preferably at least 250 rpm, more preferably at least 300 rpm, still more preferably at least 400 rpm, even more preferably at least 500 rpm, for example in the range of 100 to 1200 rpm; preferably 250 to 1200 rpm, more preferably 300 to 1000 rpm, still more preferably 350 to 800 rpm, even more preferably 400 to 600 rpm. With a variable speed drive the extrusion conditions are easier to tailor for the throughput and homogenisation conditions required.

The throughput is selected based on the desired production volume. As the person skilled in the art understands greater throughput can be achieved by extruders having a greater diameter. Useful scale-up principles for mixing is presented, among others, in Rauwendaal, Polymer Extrusion, Hanser Publishers, Munich, 1986 (ISBN 3-446-14196-0), in Table 8-4 on page 439. In some non-limiting embodiments, in lab scale the throughput is at least 4 kg/h, preferably at least 5 kg/h, more preferably at least 6 kg/h.

Other components of the final product formulation, like additives or fillers, can of course also be added if required. Additives would usually be fed together with either of the polypropylene components. Fillers would typically be added to the main extruder via a side feeder at a point after the two polypropylene components have been properly mixed.

### Polypropylene Composition

The polypropylene composition, preferably homogenous polypropylene composition obtainable by the present process as described above comprises
at least one first polypropylene (PP-A) with a weight average molecular weight (M_{w}) in the range of 300 to 1200 kg/mol, in an amount of 2 to 45 wt %, preferably 3 to 40 wt %, more preferably 4 to 35 wt %, even more preferably 5 to 30 wt %, such as 5-15 wt %, 20-25 wt % or 24 to 36 wt % (based on the overall weight of the polyolefin composition), and
at least one second polypropylene (PP-B) with a weight average molecular weight (M_{w}) in the range 50 to 400 kg/mol in an amount of 55 to 98 wt %, preferably 60 to 97 wt %, more preferably 65 to 96 wt %, even more preferably 70 to 95 wt %, such as 85-95 wt %, 75-80 wt % or 64 to 76 wt % (based on the overall weight of the polyolefin composition).

The polypropylene composition is characterized by an OCS gel index (as parameter for homogeneity) of 30 to 10,000, preferably 30 to 6000, more preferably 30 to 5500.

In some non-limiting embodiments, the polypropylene composition is further characterized by a melt flow rate MFR₂ (230° C., 2.16 kg, measured according to ISO 1133) of at least 2 g/10 min, preferably of at least 4 g/10 min, more preferably of at least 5 g/10 min, for example in the range of 2 to 175 g/10 min, preferably 4 to 100 g/10 min, more preferably 5 to 50 g/10 min, most preferably 5 to 25 g/10 min.

In some non-limiting embodiments, the polypropylene composition is further characterized by a tensile modulus at 23° C. (ISO 527-2) of at least 1000 MPa, preferably of at least 1500 MPa, more preferably of at least 1900 MPa, for example in a range of 1000 to 5000 MPa, more preferably in a range of 1500 to 2500 MPa.

In some non-limiting embodiments, the polypropylene composition obtained by the method according to the solution has an impact strength (ISO179-1, Charpy 1eA+23° C.) of at least 2 kJ/m2, preferably of at least 2.5 kJ/m2, more preferably of at least 3 kJ/m2. for example in a range of 2.0 to 5.0 kJ/m², more preferably in a range of 2.5 to 4.0 kJ/m², even more preferably in a range of 3.0 to 3.5 kJ/m²

In some non-limiting embodiments, the polypropylene composition may comprise further additives. Examples of additives for use in the composition are pigments or dyes (for example carbon black), stabilizers (anti-oxidant agents), anti-acids and/or anti-UVs, antistatic agents, nucleating agents and/or utilization agents (such as processing aid agents). Preferred additives are carbon black, at least one antioxidant and/or at least one UV stabilizer.

Generally, the amount of these additives is in the range of 0 to 5.0 wt %, preferably in the range of 0.01 to 3.0 wt %, more preferably from 0.01 to 2.0 wt % based on the weight of the total polypropylene composition.

Examples of antioxidants which are commonly used in the art, are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), or antioxidant blends. Preferred antioxidants may be Tris (2,4-di-t-butylphenyl) phosphite and/or Octadecyl 3-(3′,5′-di-tert. butyl-4-hydroxyphenyl)propionate.

Anti-acids are also commonly known in the art. Examples are calcium stearates, sodium stearates, zinc stearates, magnesium and zinc oxides, synthetic hydrotalcite (e.g. SHT, CAS-No. 11097-59-9), lactates and lactylates, as well as calcium stearate (CAS No. 1592-23-0) and/or zinc stearate (CAS No. 557-05-1).

Common antiblocking agents are natural silica such as diatomaceous earth (such as CAS No. 60676-86-0 (SuperfFloss™), CAS-No. 60676-86-0 (SuperFloss E™), or CAS-No. 60676-86-0 (Celite 499™)), synthetic silica (such as CAS-No. 7631-86-9, CAS-No. 7631-86-9, CAS-No. 7631-86-9, CAS-No. 7631-86-9, CAS-No. 7631-86-9, CAS-No. 7631-86-9, CAS-No. 112926-00-8, CAS-No. 7631-86-9, or CAS-No. 7631-86-9), silicates (such as aluminium silicate (Kaolin) CAS-no. 1318-74-7, sodium aluminum silicate CAS-No. 1344-00-9, calcined kaolin CAS-No. 92704-41-1, aluminum silicate CAS-No. 1327-36-2, or calcium silicate CAS-No. 1344-95-2), synthetic zeolites (such as sodium calcium aluminosilicate hydrate CAS-No. 1344-01-0, CAS-No. 1344-01-0, and/or sodium calcium aluminosilicate, hydrate CAS-No. 1344-01-0).

Anti-UVs are, for example, Bis-(2,2,6,6-tetramethyl-4-piperidyl)-sebacate (CAS-No. 52829-07-9, Tinuvin 770); and/or 2-hydroxy-4-n-octoxy-benzophenone (CAS-No. 1843-05-6, Chimassorb 81). Preferred UV stabilizers may be low and/or high molecular weight UV stabilizers such as n-Hexadecyl-3,5-di-t-butyl-4-hydroxybenzoate, a mixture of esters of 2,2,6,6-tetramethyl-4-piperidinol and higher fatty acids (mainly stearic acid) and/or Poly((6-morpholino-s-triazine-2,4-diyl)(1,2,2,6,6-pentamethyl-4-piperidyl)imino)hexameth-ylene (1,2,2,6,6-pentamethyl-4-piperidyl)imino)).

Alpha nucleating agents like sodium benzoate (CAS No. 532-32-1); and/or 1,3:2,4-bis(3,4-dimethylbenzylidene)sorbitol (CAS 135861-56-2, Millad 3988). Suitable antistatic agents are, for example, glycerol esters (CAS No. 97593-29-8) or ethoxylated amines (CAS No. 71786-60-2 or 61791-31-9) and/or ethoxylated amides (CAS No. 204-393-1). Usually, these additives are added in quantities of 100-2.000 ppm for each individual component of the polymer.

Further, the polypropylene composition may comprise fillers, like mineral fillers and modifiers, in an amount of up to 20% by weight of the composition, preferably up to 10% by weight of the composition, provided that such fillers have no negative impact on the properties of the composition.

The polypropylene composition according to the present disclosure is suitable for many injection molding applications, cast film extrusion and thermoforming, depending on its actual MFR.

The polypropylene composition according to the present disclosure can be used for a wide range of applications, for example in the manufacture of structural products, appliances, automotive articles, pipes, films, geo-membranes, roofing applications, pond liners, packaging, caps and closures. Additionally, due to the satisfactory tensile properties of the compositions of the present disclosure, they may be employed as films (with a thickness of 400 microns or less) or for flexible foils (with a thickness of more than 400 microns) such as geo-membranes for agriculture, roofing applications and as pond liners. Typically, the compositions described herein are used as a core layer of a multilayer sheet (e.g., a three layer geo-membrane sheet), where the external layers are made of various kinds of polyolefin materials.

### BRIEF DESCRIPTION OF THE DRAWING

The present disclosure is now explained in more detail with reference to the examples. It shows:

FIG. 1 is a schematic diagram showing an extruder set up for carrying out a process according to the principles of the present disclosure.

### DETAILED DESCRIPTION

### Experimental Section

The following Examples are included to demonstrate certain aspects and embodiments of the present disclosure as described in the claims. It should be appreciated by those of skill in the art, however, that the following description is illustrative only and should not be taken in any way as a restriction of the present disclosure.

### Test Methods

The following definitions of terms and determination methods apply for the above general description of the present disclosure as well as to the below examples unless otherwise defined.

Melt flow rates were measured with a load of 2.16 kg (MFR₂) at 230° C. The melt flow rate is that quantity of polymer in grams which the test apparatus standardized to ISO 1133 extrudes within 10 minutes at a temperature of 230° C. under a load of 2.16 kg.

### OCS—Camera Inspection of Cast Films:

The cast film samples have been produced and optically examined on a small-scale laboratory cast film line with installed camera detection from Optical Control Systems GmbH.

The line consists of an extruder with a Ø 25 mm screw with an UD ratio of 25. The extruder temperature has been set at 240° C.-260° C., the melt temperature has been 230-250° C. The extruder is followed by a die with a width of 150 mm and a fixed die gap of 0.5 mm. The film has been produced with a thickness of 70 μm. During the extrusion the chill-roll temperature has been set at 20° C.

The gels and contaminations of the film have been detected and counted on 10 m² of the film during the extrusion process with transmitted light and a 4096 pixel camera. The resolution of the camera is x/y 25 μm on film.

The camera works in transmission mode with a constant grey value (auto.set. margin level=170) by using one of two different sensitivity levels to distinguish between Gels and Contaminations. The system is able to decide between 256 grey values from black=0 to white=256. For detecting gels, a sensitivity level dark of 25% is used.

For each material the average number of gel dots on a film surface area of 10 m² was inspected by the line camera. The number of contaminations are detected in the same way.

The gels and contaminations have been divided into 4 size-classes:
class 1: 100-299 μm
class 2: 300-599 μm
class 3: 600-1000 μm
class 4: >1000 μm

The gel index was calculated as a weighted sum of the four classes, using the following formula:

$$Gel index [ - ] = 0.1 x sum class 1 + 1. x sum class 2 + 5. x sum class 3 + 10. x sum class 4$$

Tensile modulus and tensile strain at yield/break were measured according to ISO 527-2 (cross head speed=1 mm/min; test speed 50 mm/min at 23° C.) using injection molded specimens as described in EN ISO 1873-2 (dog bone shape, 4 mm thickness). The measurement is done after 96 h conditioning time of the specimen.

Impact strength was determined as notched Charpy impact strength (1eA) (non-instrumented, ISO 179-1 at +23° C.) according to ISO 179-1 eA at +23° C. on injection moulded specimens of 80×10×4 mm prepared according to EN ISO 1873-2.

### Isotacticity and Comonomer Content of Polypropylene

### Quantification of Microstructure by NMR Spectroscopy (Calibration Only)

Quantitative nuclear-magnetic resonance (NMR) spectroscopy was used for calibration.

Quantitative ¹³C{1H} NMR spectra were recorded in the solution-state using a Bruker Avance Neo 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in approximately 3 ml of 1,2-tetrachloroethane-d2 (TCE-d2) along with approximately 3 mg BHT (2,6-di-tert-butyl-4-methylphenol CAS 128-37-0) and chromium-(Ill)-acetylacetonate (Cr(acac)3) resulting in a 60 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6 k) transients were acquired per spectra.

Quantitative ¹³C{1H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

$$fE = ( E / ( P + E )$$

The comonomer fraction was quantified using the method of W-J. Wang and S. Zhu, Macromolecules 2000, 33 1157, through integration of multiple signals across the whole spectral region in the ¹³C{1H} spectra. Integral regions were slightly adjusted to increase applicability across the whole range of encountered comonomer contents.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE ⋆ 28.06 ) + ( ( 1 - fE ) ⋆ 42.08 ) ) .$$

### Crystex Analysis, Crystalline Fraction (CF) and Soluble Fraction (SF)

The crystalline (CF) and soluble fractions (SF) of the PCR polypropylene composition as well as the ethylene content and intrinsic viscosities of the respective fractions were analyzed by use of the CRYSTEX instrument, Polymer Char (Valencia, Spain) in line with ISO 6427 Annex B. Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH₃ stretching vibration (centered at app. 2960 cm⁻¹) and the CH stretching vibration (2700-3000 cm⁻¹) that are serving for the determination of the concentration and the ethylene content in ethylene-propylene copolymers. The IR4 detector is calibrated with series of 8 EP copolymers with known ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( CH 3 )$$

$${CH}_{3} / 1000 C = a + b ⋆ Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2}$$

The constants a to e for equation 1 and a to f for equation 2 were determined by using least square regression analysis.

The CH₃/1000C is converted to the ethylene content in wt.-% using following relationship:

$$Wt . - \% ( ethylene in EP copolymers ) = 100 - {CH}_{3} / 1000 TC * 0.3$$

Intrinsic viscosity (IV) of the PCR polypropylene composition and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0.077/D 0.05 mm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N₂ atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV [d/g] and the C₂ [wt.-%] of the PP composition. During the second injection the soluble fraction (at low temperature) and the crystalline fraction (at high temperature) with the crystallization cycle are measured (wt.-% SF, wt.-% CF, wt.-% C₂, IV), where the wt.-% CF is calculated in the following way:

$$wt . - \% CF = 100 - wt . - \% SF$$

### Inorganic Residues

Inorganic residues were measured by TGA according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### CIELAB Color Space (L*a*b*)

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b* coordinate axis define the three dimensional CIE color space. Standard Konica/Minolta Colorimeter CM-3700A.

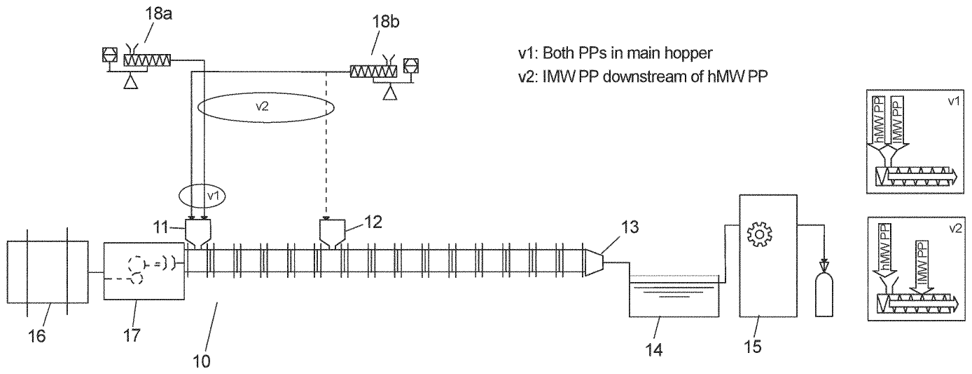

FIG. 1 shows an extruder set up for carrying out the present process.

The twin screw extruder 10 is equipped with a main hopper 11 (at the inlet of the extruder) and a side feeder as second feed port 12 downstream of the main hopper 11. The outlet 13 of the extruder is equipped with an adapter and a die plate. A water bath 14 and pelletizer 15 are arranged downstream of the extruder outlet 13. Motor 16 and gearbox 17 for operating the extruder are located at the inlet end of the extruder and drive the extruder screws. Polypropylenes and additives are added to the extruder using loss-in-weight (LIW) feeders 18a,b, wherein feeder 18a provides the high molecular weight (hMW) first polypropylene PP-A and feeder 18b provides the low molecular weight (IMW) second polypropylene PP-B.

In a first variant v1 (not according to the present disclosure) the high molecular weight polypropylene (hMW PP) and the low molecular weight polypropylene (IMW PP) are both fed to the extruder via the main hopper, subsequently molten and compounded. This is a setup that is typically used in compounding, as those skilled in the art know.

In the variant v2 (according to the present disclosure), the high molecular weight polypropylene (hMW PP) is fed to the extruder as a solid (pellets) via the main hopper. The hMW PP as the first polypropylene (PP-A) is molten in the melting section of the extruder, between the main hopper and a feed port for the low molecular weight polypropylene (IMW PP) as the second polypropylene (PP-B). The IMW PP component is fed downstream to the same extruder, either in solid form via a side feeder (shown) or as a melt via a melt pipe (not shown).

The screw design of the extruder is optimised for mixing and homogenisation of the two PP components.

The different feeding variants are compared in Table 1.

Table 1 refers to the following feeding set ups:
Comparative Example CE1: according to variant v1 5 wt % of the high molecular weight polypropylene PP-A1 are fed together with 95 wt % of the low molecular weight polypropylene PP-B2 to the extruder (screw speed 400 rpm),
Inventive Example IE1: according to variant v2 5 wt % of the high molecular weight polypropylene PP-A1 are fed first and 95 wt % of the low molecular weight polypropylene PP-B2 are fed downstream to the extruder (screw speed 400 rpm),
Comparative Example CE2: according to variant v1 15 wt % of the high molecular weight polypropylene PP-A1 are fed together with 85 wt % of the low molecular weight polypropylene PP-B2 to the extruder (screw speed 400 rpm),
Inventive Example IE2: according to variant v2 15 wt % of the high molecular weight polypropylene PP-A1 are fed first and 85 wt % of the low molecular weight polypropylene PP-B2 are fed downstream to the extruder (screw speed 400 rpm),
Comparative Example CE3: according to variant v1 25 wt % of the high molecular weight polypropylene PP-A1 are fed together with 75 wt % of the low molecular weight polypropylene PP-B1 to the extruder (screw speed 600 rpm),
Inventive Example IE3: according to variant v2 24 wt % of the high molecular weight polypropylene PP-A1 are fed first and 76 wt % of the low molecular weight polypropylene PP-B1 are fed downstream to the extruder (screw speed 600 rpm),
Comparative Example CE4: according to variant v1 33 wt % of the high molecular weight polypropylene PP-A1 are fed together with 67 wt % of the low molecular weight polypropylene PP-B1 to the extruder (screw speed 600 rpm),
Inventive Example IE4: according to variant v2 36 wt % of the high molecular weight polypropylene PP-A1 are fed first and 64 wt % of the low molecular weight polypropylene PP-B1 are fed downstream to the extruder (screw speed 600 rpm),
Comparative Example CE5: according to variant v1 5 wt % of the high molecular weight polypropylene PP-A1 are fed together with 95 wt % of the low molecular weight polypropylene PP-B2 to the extruder (screw speed 400 rpm),
Inventive Example IE5: according to variant v2 5 wt % of the high molecular weight polypropylene PP-A1 are fed first and 95 wt % of the low molecular weight polypropylene PP-B2 are fed downstream to the extruder (screw speed 400 rpm),
Comparative Example CE6: according to variant v1 35 wt % of the high molecular weight polypropylene PP-A1 are fed together with 65 wt % of the low molecular weight polypropylene PP-B1 to the extruder (screw speed 400 rpm),
Inventive Example IE6: according to variant v2 35 wt % of the high molecular weight polypropylene PP-A1 are fed first and 65 wt % of the low molecular weight polypropylene PP-B1 are fed downstream to the extruder (screw speed 400 rpm).

TABLE 1

| | | CE1 | IE1 | CE2 | IE2 | CE3 | IE3 |
|---|---|---|---|---|---|---|---|
| Setup | | v1 | v2 | v1 | v2 | v1 | v2 |
| Screw speed | [rpm] | 400 | 400 | 400 | 400 | 600 | 600 |
| Throughput | [kg/h] | 6 | 6 | 6 | 6 | 6 | 6 |
| Dimensionless | [—] | 0.058 | 0.058 | 0.058 | 0.058 | 0.039 | 0.039 |
| throughput Q | | | | | | | |
| PP-B1 | | 0% | 0% | 0% | 0% | 75% | 76% |
| PP-B2 | | 95% | 95% | 85% | 85% | 0% | 0% |
| PP-A1 | | 5% | 5% | 15% | 15% | 25% | 24% |
| MFR ratio | | ~60 | ~60 | ~60 | ~60 | ~350 | ~350 |
| MFR2 | [dg/min] | 12.5 | 10.0 | 6.1 | 6.2 | 15.6 | 15.2 |
| OCS gel index | [—] | 1131 | 378 | 173 | 37 | 28362 | 5462 |
| OCS CE→IE | | | −67% | | −79% | | −81% |
| Tensile | [MPa] | 1797 | 1904 | 1947 | 2004 | | |
| modulus | | | | | | | |
| Tmod CE→IE | | | 6.0% | | 2.9% | | |
| Charpy impact | [kJ/m²] | 2.69 | 3.26 | 3.34 | 3.47 | | |
| strength (1eA | | | | | | | |
| 23° C.) | | | | | | | |
| IS CE→IE | | | 21% | | 4% | | |
| | | CE4 | IE4 | CE5 | IE5 | CE6 | IE6 |
| Setup | | v1 | v2 | v1 | v2 | v1 | v2 |
| Screw speed | [rpm] | 600 | 600 | 400 | 400 | 400 | 400 |
| Throughput | [kg/h] | 6 | 6 | 30 | 30 | 30 | 30 |
| Dimensionless | [—] | 0.039 | 0.039 | 0.078 | 0.078 | 0.078 | 0.078 |
| throughput Q | | | | | | | |
| PP-B1 | | 67% | 64% | 0% | 0% | 65% | 65% |
| PP-B2 | | 0% | 0% | 95% | 95% | 0% | 0% |
| PP-A1 | | 33% | 36% | 5% | 5% | 35% | 35% |
| MFR ratio | | ~350 | ~350 | ~60 | ~60 | ~350 | ~350 |
| MFR2 | [dg/min] | 9.9 | 5.9 | 10.1 | 9.5 | 6.5 | 5.9 |
| OCS gel index | [—] | 3503 | 178 | 7604 | 953 | 9651 | 4718 |
| OCS CE→IE | | | −95% | | −87% | | −51% |
| Tensile | [MPa] | | | 1747 | 1776 | 1877 | 1877 |
| modulus | | | | | | | |
| Tmod CE→IE | | | | | 2% | | 0% |
| Charpy impact | [kJ/m²] | | | 3.02 | 3.04 | 3.11 | 3.34 |
| strength (1eA | | | | | | | |
| 23° C.) | | | | | | | |
| IS CE→IE | | | | | 1% | | 7% |

As can be seen in Table 1, the OCS gel index as an indicator of homogeneity depends on the mixing setup; the lower the OCS gel index, the better the homogeneity.

OCS gel index generally increases with the MFR ratio and decreases with increasing content of the high MW PP component (PP-A1). As to the processing, variant v2 always provides lower gel index values and thus better homogeneity compared to variant v1. For the examples shown in Table 1, gel index is reduced by approximately 50-95% when switching from v1 to v2.

1. A process for producing a homogenous polypropylene composition comprising:
a) Feeding and at least partially melting at least one first polypropylene (PP-A) having a first melt flow rate MFR₂ (PP-A) in an extruder;
wherein the at least one first polypropylene (PP-A) has a melt flow rate MFR₂ (230° C., 2.16 kg, measured according to ISO 1133) of ≤2.0 g/10 min;
b) Feeding at least one second polypropylene (PP-B) having a second melt flow rate MFR₂ (PP-B) downstream of feeding the first polypropylene (PP-A) into said extruder,
wherein the first melt flow rate MFR₂ (PP-A) is lower than the second melt flow rate MFR₂ (PP-B) and wherein the ratio of MFR₂ (PP-B)/MFR₂ (PP-A) is ≥30;
c) Compounding the at least one first polypropylene (PP-A) and the at least one second polypropylene (PP-B) in said extruder to form a homogenous polyolefin composition,
wherein the process is carried out in an extruder with a dimensionless throughput Q of >0.035.

2. The process according to claim 1, wherein the ratio of MFR₂ (PP-B)/MFR₂ (PP-A) is ≥50.

3. The process according to claim 1, wherein the at least one first polypropylene (PP-A) is provided in an amount of 2 to 45 wt % (based on the overall weight of the polyolefin composition).

4. The process according to claim 1, wherein the at least one second polypropylene (PP-B) is provided in an amount of 55 to 98 wt % (based on the overall weight of the polyolefin composition).

5. The process according to claim 1, wherein the at least one first polypropylene (PP-A) has a melt flow rate MFR₂ (230° C., 2.16 kg, measured according to ISO 1133) of 0.10 to 1.0 g/10 min.

6. The process according to claim 1, wherein the at least one first polypropylene (PP-A) has an average molecular weight (Mw) of 300 to 1200 kg/mol.

7. The process according to claim 1, wherein the at least one second polypropylene (PP-B) has a melt flow rate MFR₂ (230° C., 2.16 kg, measured according to ISO 1133) of 9 to 1000 g/10 min.

8. The process according to claim 1, wherein the at least one second polypropylene (PP-B) has an average molecular weight (Mw) of 25 to 400 kg/mol.

9. The process according to claim 1, wherein at least one of the first polypropylene (PP-A) is recycled polypropylene obtained in a chemical recycling or so called feedstock recycling process and/of the second polypropylene (PP-B) is a mixed-plastics polypropylene blend of recycled material.

10. The process according to claim 1, wherein the process is carried out in an extruder with a dimensionless throughput Q of >0.035.

11. The process according to claim 1, wherein the screw speed of the extruder is at least 100 rpm.

12. The process according to claim 1, wherein the extruder comprises a melting section between the main hopper for feeding the at least one first polypropylene (PP-A) and a feed port downstream of the main hopper for feeding the at least one second polypropylene (PP-B).

13. The process according to claim 1, wherein the final polypropylene composition has an OCS gel index (as parameter for homogeneity) of 30 to 10,000.

14. The process according to claim 1, wherein the final polypropylene composition has a melt flow rate MFR₂ (230° C., 2.16 kg, measured according to ISO 1133) of at least 2 g/10 min.

15. A polypropylene composition obtainable by a process according to claim 1, comprising
at least one first polypropylene (PP-A) with a weight average molecular weight (Mw) of 300 to 1200 kg/mol in an amount of 2 to 45 wt % (based on the overall weight of the polyolefin composition), and
at least one second polypropylene (PP-B) with a weight average molecular weight (Mw) of 25 to 400 kg/mol in an amount of 55 to 98 wt % (based on the overall weight of the polyolefin composition),
having an OCS gel index (as parameter for homogeneity) of 30 to 10,000.

16. The polypropylene composition according to claim 14, having a melt flow rate MFR₂ (230° C., 2.16 kg, measured according to ISO 1133) of at least 2 g/10 min.

17. The process according to claim 2, wherein the ratio of MFR₂ (PP-B)/MFR₂ (PP-A) is ≥60.

18. The process according to claim 3, wherein the at least one first polypropylene (PP-A) is provided in an amount of 3 to 40 wt % (based on the overall weight of the polyolefin composition).

19. The process according to claim 4, wherein the at least one second polypropylene (PP-B) is provided in an amount of 60 to 97 wt % (based on the overall weight of the polyolefin composition).

20. The process according to claim 5, wherein the at least one first polypropylene (PP-A) has a melt flow rate MFR₂ (230° C., 2.16 kg, measured according to ISO 1133) of 0.15 to 0.50 g/10 min.
